(19) United States
(12) Patent Application Publication
(10) Pub. No.: US 2025/0371614 A1
(43) Pub. Date: Dec. 4, 2025

(54) METHOD AND SYSTEM INCLUDING TRAINED SUBSYSTEMS FOR CALCULATING AND MANAGING DEFAULT RISKS OF LOAN BASED ON MULTIPLE, TIME-VARYING DATA SOURCES

(71) Applicant: Laboratory for AI-Powered Financial Technologies Limited, Hong Kong (CN)

(72) Inventors: Di Wu, Hong Kong (CN); Houmin Yan, Hong Kong (CN)

(73) Assignee: Laboratory for AI-Powered Financial Technologies Limited, Hong Kong (CN)

(21) Appl. No.: 18/929,683

(22) Filed: Oct. 29, 2024

Related U.S. Application Data
(60) Provisional application No. 63/655,696, filed on Jun. 4, 2024.

(51) Int. Cl. G06Q 40/03; G06Q 20/14

(52) U.S. Cl. CPC G06Q 40/03; G06Q 20/14

(57) ABSTRACT

A system and method for providing a loan to a merchant hosting one or more shops on an e-commerce platform is disclosed. The method includes, in response to receiving a request for a loan with a specified repayment term, obtaining first data from a public data source and second data from the e-commerce platform. These inputs are provided to a trained predictor which outputs a distribution of estimated future revenue for the merchant over the repayment term. The system uses the estimated future revenues and the merchant's cash in a payment account as collateral to assess loan risk. A default probability value (PD) and a loss-given-default value (LGD) associated with potential loan amounts and interest rates are calculated. Based on the PD and LGD, one or more feasible contracts are determined, including a target loan amount and interest rate, and at least one loan contract is generated for the merchant.

### CROSS-REFERENCE TO RELATED APPLICATION

This application claims benefit to U.S. Provisional Application 63/655,696 filed Jun. 4, 2024, the content of which is incorporated by reference in its entirety.

### TECHNICAL FIELD

The present disclosure relates to using artificial intelligence (AI) technology to process data obtained from multiple, time-varying data sources and in particular, to a method and system including trained subsystems for calculating and managing default risks of a loan based on multiple, time-varying data sources obtained from electronic commerce platforms.

### BACKGROUND

In electronic commerce (referred to as “e-commerce”), an e-commerce operator company (e.g., Amazon, Temu referred to as “platform”) operates an e-commerce platform (or a web service) on which a third-party seller company (referred to as a “merchant”) may operate one or more online shops (referred to as “shops”). The merchant may sell merchandises through its shops operated on the platform to online shoppers or customers. In exchange for a service fee, the platform may provide logistic support to the merchant in dealing customers, the logistic support including, but not limited to, transacting sales, fulfilling the sold goods, collecting sale receipts, and supporting after-sale exchanges, returns, and refunds. The platform may complete the underlying sales to the customers in all shops on behalf of the merchant, including collecting money of the sale receipts from the customers. The platform may keep a cash account for the merchant, and then transfer the collected money to the merchant after deducting its service fees according to an agreed-upon schedule.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an ecosystem including a computing system for calculating and managing default risks of issuing loans to an e-commerce merchant according to an implementation of the disclosure.

FIG. 2 illustrates a computing framework that can calculate the future estimated revenue and its volatility value according to an implementation of the disclosure.

FIG. 3 illustrates a system for deciding on a loan and managing the loan according to an implementation of the disclosure.

FIG. 4 illustrates a flowchart of a method for generating a loan contract to an e-commerce merchant based on estimated sale revenue and its volatility value according to an implementation of the disclosure.

FIG. 5 depicts a block diagram of a computer system operating in accordance with one or more aspects of the present disclosure.

### DETAILED DESCRIPTION

Merchants operating e-commerce shops often need to borrow money from financial institutions as working capital. The borrowed money, referred to as a loan, is commonly governed by a borrowing agreement (or loan contract) that specifies a total amount of borrowed money (or loan amount), a length of the loan (term or repayment term), a repayment schedule (e.g., repayment or how much to pay monthly or at maturity), and an interest rate associated with the loan. Before issuing the loan, financial institutions need to assess the risk that the merchant might default on the loan. The borrowing agreement may also specify remedies in case of default or failure to make payments. To issue a loan, the financial institution needs to evaluate the borrower's ability to repay the loan or the risk of default before issuing the loan. The risk of default may determine the specific requirements laid out in the borrowing agreement including the total borrowed amount, the length of the loan, the repayment schedule, the interest rate, and the remedies in case of the default.

Although lending to e-commerce merchants is increasingly common, large banks have traditionally been hesitant to participate in this type of lending due to the challenges in accurately assessing the risk associated with these loans. Unlike public companies, e-commerce merchants are commonly small or micro companies whose financial information (e.g., cash reserves, asset values, existing debts) may not be quantitatively observable for a party that is not authorized by the merchant to accessing the merchant's financial data. Furthermore, the cash flow (i.e., the net cash and cash equivalents transferred into the merchant's account), which is typically a merchant's primary asset, has not been widely recognized as collateral for loans due to the challenges in accurately evaluating it. The cash flow of an e-commerce merchant can fluctuate significantly, influenced by various factors, and financial institutions often lack the tools to monitor these fluctuations in real-time. Moreover, merchants can redirect their cash flow to other accounts outside the lender's control, thereby increasing the risk and uncertainty for the lender.

To overcome these identified and other challenges, implementations of the disclosure provide a system and method that allow future revenue to be used as collateral in a manner that large financial institutions, such as banks, can confidently apply the collateral. The system operates in a closed-loop configuration, where all proceeds from sales are automatically routed to a payment account associated with a merchant. The closed-loop configuration ensures that the funds are securely managed, preventing the merchant from diverting funds to other accounts.

The system further provides financial institutions with real-time visibility of the merchant's activities, enabling dynamic risk assessment (including real-time or near real-time risk assessment) as new data is captured and analyzed. This real-time monitoring allows for effective management of the merchant's cash flow and future revenue streams, providing a secure basis for lending decisions. The controllability of the system enables financial institutions to monitor and adjust their strategies in response to real-time data, thereby reducing the risk of default by the merchant.

A central component of this disclosure is the ability to forecast not only how much revenue a merchant might generate in the future but also how this revenue could vary over time using computer technologies specially designed for this application. By leveraging big data and machine learning technologies grounded in modern finance principles, these forecasts allow for the calculation of the likelihood that a merchant might default on the loan, known as Probability of Default (PD), and the potential losses the bank could face if a default occurs, known as Loss Given Default (LGD). These calculations are helpful for meeting the requirements of financial regulations such as Basel III and for managing risks within the bank itself.

Another key component of this invention is the ability for financial institutions to collaborate with e-commerce platforms and payment companies to initiate payments, lock funds, freeze accounts, and facilitate repayments. The system is implemented on advanced computing infrastructure, such as clusters of processing devices (e.g., Nvidia A100, H100 Tensor Core GPUs or any hardware processors that are capable of performing the disclosed computations) or a computing cloud (e.g., AWS cloud), to process a broad range of data points, including historical sale data and non-traditional data sources such as transaction history, customer feedback, and online behavior patterns.

Implementations of the disclosure may provide a system including one or more processing devices and one or more storage devices for storing instructions that, when executed by the one or more processing devices, cause the one or more processing devices to, responsive to receiving a request by a merchant hosting one or more shops on an e-commerce platform for a loan with a repayment term, obtain first data from a public data source and second data from the e-commerce platform, wherein the first data and the second data may include a variety of inputs such as historical revenue, transaction history, customer behavior, and other relevant metrics associated with the merchant's shops, as well as the cash in a payment account linked to the merchant; provide the first data and the second data as inputs to a trained predictor and execute the trained predictor to output a distribution of estimated future revenue for the merchant over the repayment term; calculate, based on this distribution and, where applicable, the cash in the payment account, which can be considered as the collateral or part of the collateral if the repayment date is sufficiently close, a PD value and a LGD value associated with the merchant; determine, based on the PD value and the LGD value, one or more feasible contracts including a target loan amount and a loan interest; and generate at least one loan contract for providing the loan to the merchant with the target loan amount and the loan interest rate.

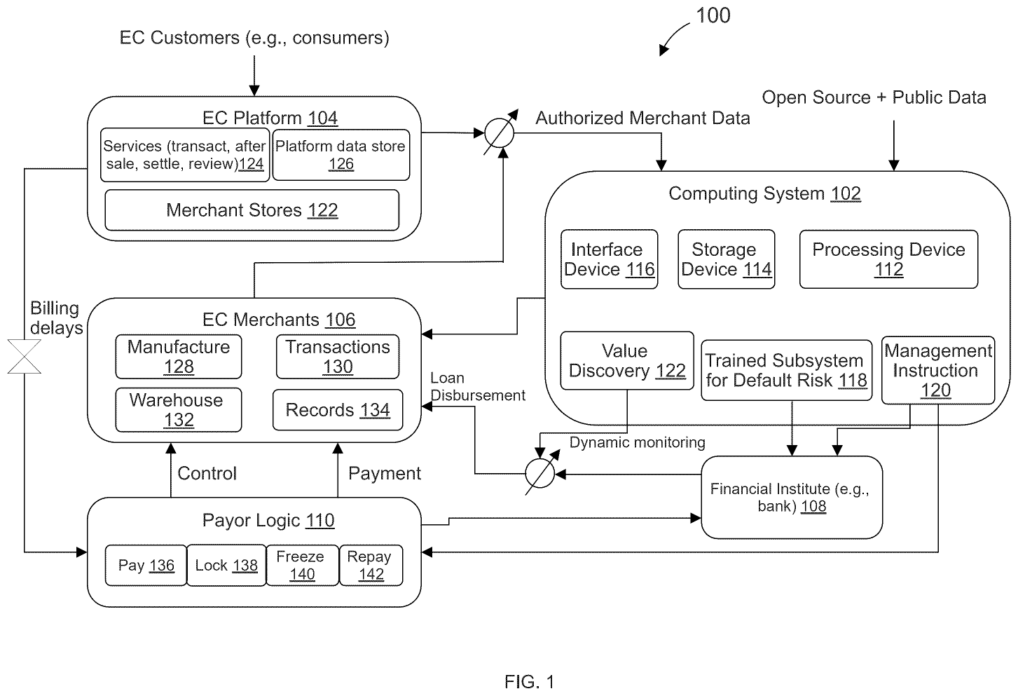

FIG. 1 illustrates an ecosystem 100 including a computing system 102 for calculating and managing default risks of issuing loans to an e-commerce merchant according to an implementation of the disclosure. Referring to FIG. 1, ecosystem 100 may include computing system 102 to perform operations that calculate the default risks and manage the loan based on the calculated default risks. Computing system 102 may be connected to an e-commerce platform 104, a computing system of an e-commerce merchant 106, a financial institution 108, and a payment control logic (or payor logic) 110 for managing loans on behalf of financial institutions through a network infrastructure (not shown). In the context of e-commerce, a merchant 106 may manufacture 128 and store (e.g., warehouse) 132 merchandises. Merchant 106 may open one or more online shops 122 to sell these merchandises to consumers or e-commerce customers at an e-commerce platform (e.g., Amazon, Temu etc.) 104 that is implemented on computing resources such as clusters of hardware processors or a computing cloud.

E-commerce platform 104 provides a wide range of services (e.g., transact with customers, sales settlement or collecting sale receipts from customers, after sale services including return by customers and refunds to customers, customer reviews of the merchandises) to merchants 106 that have set up shops 122 on e-commerce platform 104. Additionally, e-commerce platform 104 may also record every transaction made on the platform between customers and merchants 106 and store the recorded data in platform data store 126. E-commerce platform 104 may continuously record data relating merchants 106. Thus, the recorded data stored in platform data store 126 may continuously grow over time. The recorded data may include numerical values (e.g., sale receipts), natural language texts (e.g., customer reviews and feedback), and customer behavior patterns (e.g., return rates). The nonhomogeneous and time-varying data stored in platform data store 126 contain rich information about merchants 106. Utilization of and extraction of useful information from the unconventional data stored there requires improvements to the existing technical solution. For a particular merchant 106, it may correspondingly record its transactions 130 with customers and stored these transactions in records 134.

Applicants of this disclosure recognize that existing models for calculating default risk associated with issuing loans are not suitable for assessing risks of lending to e-commerce merchants because the existing models rely upon static financial data (e.g., assets, or stock prices) that are public available. E-commerce merchants that sell merchandises on an e-commerce platform are commonly small businesses and do not have reliable high-quality static financial data that are publicly available, and even when they are available, such data are poor indicators of default risks due to the rapid changes in business environments driven by macro and micro economic factors. Instead of solely relying on publicly available static data, implementations of the disclosure build a specialized model for assessing default risks of e-commerce merchants based on an estimated future revenue and cash in the pipeline. The estimated future revenue may serve as a collateral or part of a collateral against the loan, while its uncertainty helps determine the maximum loan amounts and associated interest rates. Thus, implementations of the disclosure use advanced computer technologies to improve the evaluation of an e-commerce merchant's borrowing ability, the determination of loan agreement requirements, the design of loan products, and the management and enforcement of those requirements. Furthermore, implementations of the disclosure enhance data processing technologies by providing methods for cleansing and regularizing complex authorized and public data of e-commerce merchants, and by using a trained subsystem to estimate the distribution of future revenue, thereby obtaining a reliable and meaningful default risk assessment. In this way, implementations of the disclosure provide systems and methods for issuing and managing loans to the underserved e-commerce merchants using improved computer technologies.

Computing system 102 may be programmed with software application to perform operations of the implementations. Computing system 102 can be a standalone computer or a networked computing resource implemented in a computing cloud or an integral part of e-commerce platform 106 (or part of a computing system of financial institution 108). Referring to FIG. 1, computing system 102 may include one or more processing devices 112, a storage device 114, and an interface device 116, where the storage device 104 and the interface device 116 are communicatively coupled to processing devices 112 by communication links in computing system 102 and to external networks through a communication interface device.

In one implementation, processing device 112 can be a hardware processor such as a central processing unit (CPU), a graphic processing unit (GPU), or an accelerator circuit. Interface device 116 can be a display such as a touch screen of a desktop, laptop, or smart phone. Storage device 114 can be a memory device, a hard disc, or a cloud storage connected to processing device 112 through communication interface device.

Processing device 112 can be a programmable device capable of implementing software applications. In one implementation, processing device 112 may be programmed to implement a trained subsystem application 118 for calculating default risks based on both public data and authorized merchant data. Public data are information accessible to everyone, such as news stories, economic surveys, and reports about the merchant, entities associated with the merchant (e.g., suppliers, competitors), and the merchant's industry. The authorized merchant data are not publicly available but are instead data that e-commerce merchants 106 authorize to be transferred from e-commerce platform 104 to computing system 102 for the purpose of computing default risk. These authorized merchant data can include real-time data, such as cash in a merchant's account, sales data from different stores of the merchant and optionally, sales data from other merchants. The sale data may include sales receipts and returns over the specific periods.

Trained subsystem application 118 may use both public data and authorized merchant data as inputs to estimate the full distribution of the merchant's future revenue. The distribution is then used to calculate the merchant's default risk. Additionally, processing device 112 may implement a loan management instruction function 120 that, based on the calculated default risks, issues instructions about the loan for financial institution 108 and/or payor logic 110 to execute. The instructions may include, but not limited to, pay 136, lock 138, freeze 140, and repay 142.

At the initiation of a loan, if a merchant qualifies for a loan based on an assessment of its default risks calculated from the future estimated revenues and volatilities, financial institution 108 may lock 138 to fix the merchant to a specific account. When the default risk calculated by trained subsystem 118 indicates that it is safe to issue the loan requested by the merchant, loan management instruction function 120 may issue a pay instruction 136, directing financial institution 108 and payor logic 110 to disburse the loan or pay to e-commerce merchant 106. Processing device 112 may also implement a value discovery function 122 that continuously monitors changes in the merchant's default risks and adjusts the instruction accordingly.

If the default risk increases, based on factors such as the cash in the merchant's account, updates from the latest sale data, and/or the merchant's loan repayment behavior, loan management instruction function 120 may issue a freeze instruction 140 to halt further disbursement or initiate a repayment request to the merchant until sales improve. Should the sales improve, and the calculated default risk decreases to a level that allows for loan disbursement, loan management instruction function 120 may issue pay instruction 136 again. Conversely, if the default risk increases further, loan management instruction function 120 may issue a repay instruction 142, requesting e-commerce platform 104 to use funds in the merchant's account on the platform to repay the outstanding loan to financial institution 108. In this way, ecosystem 100 effectively manages the loan based on a merchant's time-varying default risk.

In one implementation, computing system 102 may receive an application requesting for a loan from an e-commerce merchant operating one or more shops on an e-commerce platform. In response, computing system 102 may obtain authorized merchant data, including cash in the merchant's account, and both historical and real-time data such as sales information, transaction history, customer behavior, and inventory levels across all shops operated by the merchant. The system, using a trained subsystem, may calculate the full distribution of the merchant's future revenue based on this comprehensive data set and relevant public data. This distribution, along with the cash in merchant's account (applicable for very short term loan), may be used to determine the range of loans options, including varying loan amounts, maturity terms (e.g., from one to 12 months), and interest rates. In determining the loan terms, computing system 102 may also consider additional factors, such as the risk management policies set forth by the financial institution and relevant government regulation, which may impose limits on the maximum credit available to the merchant. Furthermore, a profitability constraint may be applied to set a minimum interest rate. The combination of these constraints, along with the estimated revenue distribution, may be used to define a feasible set of loan contracts that can be offered to the merchant.

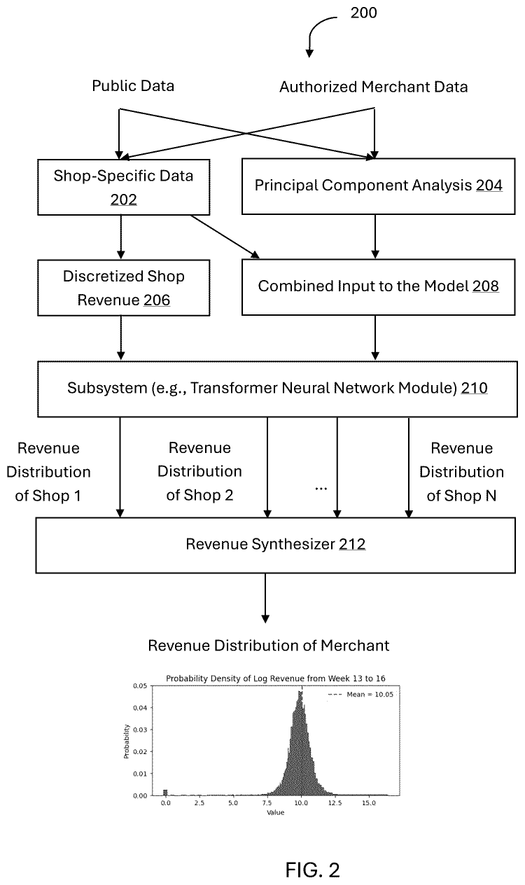

FIG. 2 illustrates an implementation of computing framework 200, which is designed to calculate the full distribution of future revenue according to an implementation of the disclosure. Computing framework 200 is engineered to process diverse types of big data that can rapidly change over time. In one implementation, computing framework 200 may be implemented as an executable code by processing device 112 as shown in FIG. 1. Referring to FIG. 2, computing framework 200 may acquire public data from public sources and authorized merchant data from one or more e-commerce platforms. Public data may include, but not limited to, news stories and economic surveys and reports about the merchant, entities associated with the merchant (e.g., suppliers, competitors), and the industry to which the merchant belongs. Authorized merchant data may include a wide range of sales-related data. This includes both historical and current sales data not only for the merchant seeking a loan but also for other merchants on the platform. The sales-related data for a specific merchant may include detailed metrics such as sales volume, product pricing, revenue, sales rankings of products compared to others, customer ratings relative to other merchants, and customer reviews. Additionally, this data can be broken down further to include detailed figures such as the sales performance of each individual shop operated by the merchant and the sales of each product offered by the merchant. Collectively, this sales-related data provides a comprehensive overview of the merchant's operations, enabling an accurate estimation of the future revenue distribution.

The public data and the authorized merchant data may be in the form of a sequence of data structures (e.g., vectors), where the sequence is aligned according to the time or the order in which the data was captured. Each data structure within the sequence may contain data recorded for a determined duration of time (e.g., a day, a week, or a month). Thus, the whole sequence may correspond to data recorded for an accumulated duration (e.g., a week, a month, or a year). Each data structure can be very large due to the large number of merchants and the large number of attributes of the sales-related data for each merchant. The processing device may perform preprocessing operations to reduce the dimensionality of the data structures by eliminating redundancies in the data.

Each data structure may include a large amount of data elements that could be difficult to process in its raw form. To simplify the processing, in one implementation, at 202, the processing device may first calculate shop-specific data based on the public data and the authorized merchant data. The shop-specific data represent the sales-related data for shops of the merchant and include variable values such as past sales, rating, and ranking, which are specific to each shop, including both public data and merchant-authorized data. To account for the uncertainty in the output revenue, at 206, the processing device may discretize the shop-specific data into bins. In one implementation, the logarithmic values of the possible range of revenues are divided into bins designed to approximate a normal distribution.

Correspondingly, at 204, the processing device may first perform Principal Component Analysis (PCA) on the sequence of data structures combining both the public data and the authorized data. PCA transforms the data into a new coordinate system with lower dimensionality by identifying the principal components that capture the most significant variations in the data. In one implementation, PCA 204 may reduce the dimensionality of the input data to a fixed number of dimensions (e.g., 10 or 20), which are pre-selected based on their contribution to the total variance in the data. The output of PCA 204 includes principal component values (eigenvalues), each corresponding to a principal component (eigenvector). In one implementation, PCA 204 may reveal that the first ten principal components capture up to 96% of the total information.

At 208, the processing device may integrate both the principal components derived from the broader merchant data and the shop-specific input features for each shop operated by the merchant applying for the loan. This combination of inputs feeds into the model that uses the integrated data to predict the full distribution of future revenue for the merchant.

The processing device may train a subsystem 210 to calculate a probability distribution of these discretized revenue bins, using both the shop-specific variables and principal component values as inputs. The trained subsystem 208 can be any suitable predictor system capable of generating a probability distribution over the discretized revenue. In one implementation, the trained subsystem may be implemented as a transformer neural network module. This trained transformer neural network module may employ a multi-headed attention mechanism, where each head attends to different parts of the time series data to capture various temporal dependencies and patterns.

In one implementation, the trained transformer neural network module may employ positional encoding to ensure that the time series data is processed in a proper chronological order (i.e., earlier data points are recognized as occurring before later data points).

During the training process, the training data is input into the subsystem 210 to generate an intermediate output. In one implementation, subsystem 210 may include a softmax activation function that converts the intermediate output into the vector of probabilities or a probability distribution over the revenue bins. The model's parameters may be adjusted based on the cross-entropy loss between the predicted probability distribution and the observed revenue data. This process may be repeated over a pre-specified number of epochs, with training data being re-input into the subsystem to generate further intermediate probability distributions and adjust the parameters based on the cross-entropy loss over each epoch.

The processing device may further utilize a revenue synthesizer 212 to aggregate the shop-level revenue distributions into a merchant-level (i.e., the borrower of the loan) revenue distribution. In one implementation, synthesizer 212 may perform a bootstrap analysis based on all shop-level distributions under the same merchant. This approach is suitable because the inclusion of principal component values in subsystem 210 accounts for the correlation among shop revenues. Additionally, synthesizer 212 may extend the bootstrap analysis over multiple periods, using an autoregressive approach where the output from one period is incorporated as part of the input for the next period.

A hypothetical example of revenue distribution for a merchant is illustrated in FIG. 2, showing the probability density of the log revenue forecasted for future weeks 13 to 16. In the example, the model predicts a small but non-zero probability of closure, indicated by zero revenue. The remainder of the distribution closely approximates a log-normal distribution.

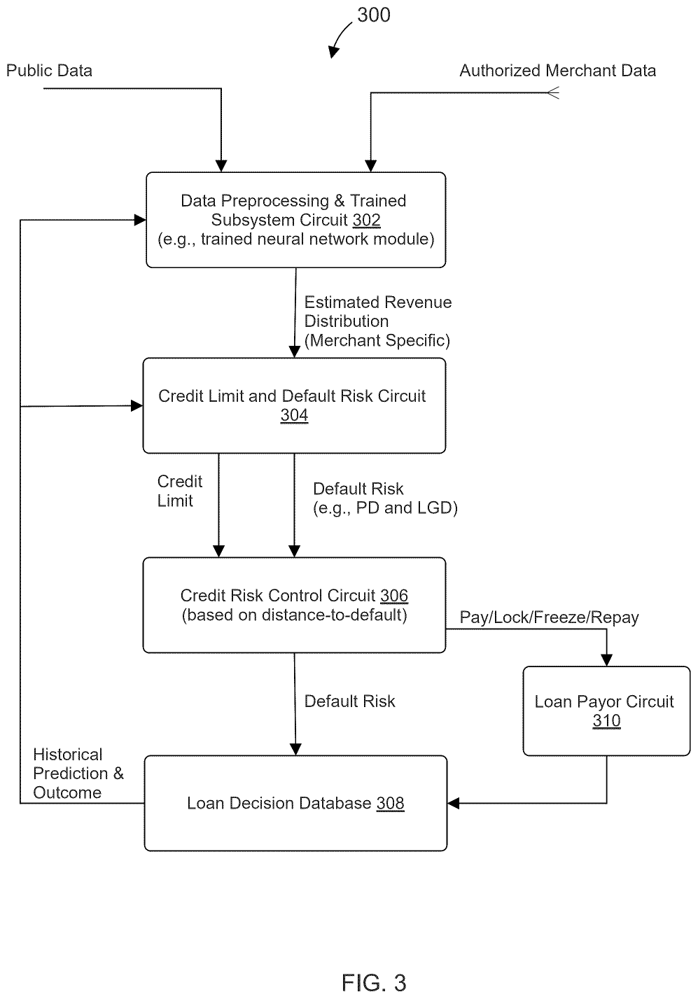

Building on the data preprocessing and trained subsystem, system 300 is configured to make loan decisions and manage loans according to an implementation of the disclosure. Referring to FIG. 3, system 300 may include data preprocessing and trained subsystem circuit 302 (as described in detail along with FIG. 2) that output the distribution of merchant-level revenue in a future month t. System 300 may further take into account cash available in the merchant's payment account, which constitutes a certain and immediate form of collateral. By combining the uncertain future revenue with the certain cash in the payment account, the system 300 evaluates the distribution of the total collateral available to support the loan. This distribution can be characterized by a cumulative distribution function Fₜ(·), incorporating both the estimated future revenues and the cash in the payment account.

System 300 may include a credit limit and default risk circuit 304 that may determine a credit limit L, Probability of Default (PD), and Loss Given Default (LGD) associated with the loan. In one implementation, circuit 304 may adopt a stringent criterion by treating all occurrence where the realized revenue of the merchant is lower than the scheduled payment in any month as a default, and treating all subsequent payments as loss. When the loan is amortized and repaid in T months, for a loan with monthly interest rate r, the scheduled payment is

$$P = \frac{rL}{1 - {( 1 + r )}^{- T}} .$$

The discounted expected cashflow equals:

$$E = {\sum }_{t = 1}^{T} {\prod }^{( t - 1 )} [ P \cdot ( 1 - {F}_{t} ( P ) ) + {E}_{P} \cdot {F}_{t} ( P ) ] {( 1 + {r}^{f} )}^{- t} \qquad ( 1 )$$

where E_{P} is the expected revenue conditional on the revenue being lower than P,

$${\prod }^{( t - 1 )} = {\prod }_{i = 1}^{t - 1} ( 1 - {F}_{i} ( P ) )$$

r^{f} is the discount rate of the bank. The credit limit L may be determined by equaling it to the discounted expected cashflow, i.e., E=L. The associated PD may be represented by 1−Π^{(T)}, and LGD may be calculated by determining the difference between the outstanding loan balance at the time of default and the expected recovery from the collateral.

Based on the calculations and determinations outlined above, System 300 introduces a novel approach that is particularly suitable for banks. This approach is characterized by three key aspects. Firstly, System 300 operates within a closed-loop configuration, where all proceeds generated from sales by the merchant are automatically routed to a payment account associated with a merchant. This payment account associated with merchant may include cash belong to the merchant. Secondly, the system provides authorized real-time sales data, enabling detailed observation of the merchant's activities. Thirdly, the system utilizes the cash in the payment account and estimated future revenues as collateral, offering a more precise and dynamic assessment of a merchant's repayment capacity, particularly for small and micro-enterprises that may lack publicly available financial information.

In addition to being closed-loop, observable, and controllable, System 300 is designed to be flexible by accommodating generic revenue distribution and accounting for revenue co-movement across shops and over time. This flexibility enables the financial institution to design adaptable loan contract, presenting a significant improvement over the traditional approaches such as the KMV method (U.S. Pat. No. 6,078,903 to Kealhofer et al.), which primarily focuses on public companies and assumes log-normal stock price distribution. In one implementation, the merchant may apply for a term loan, which involves a single repayment at the maturity of the loan (i.e., a fixed date for repayment). The processing device assesses the probability distribution of the merchant's revenue and may determine whether the revenue distribution approximates normality based on statistical tests such as the Shapiro-Wilk test or the Anderson-Darling test. If the distribution is deemed to follow a log-normal pattern, circuit 304 can simplify the analysis by employing a procedure similar to the standard KMV procedure.

However, unlike the KMV model, which is limited to public companies and interprets the borrower's stock as a call option on the borrower's assets, system 300 improves the current KMV model to include private merchants by conceptualizing the loan as a short put option on the merchant's revenue, combined with a risk-free bond. In the KMV model, the borrower's debt serves as the strike price, and shareholders, like call option holders, benefit only if the borrower's assets exceed its liabilities. Similarly, in the credit limit and default risk circuit 304, the loan amount functions as the strike price, but instead of focusing on the company's assets, the model assesses the merchant's revenue. The financial institution faces a risk analogous to that of a short put option writer: a substantial decline in the merchant's revenue could lead to losses, mirroring the scenario where the asset value falls below the strike price in a short put option.

The following formulas are provided to illustrate the concepts discussed above. Here, revenue distributions are modeled as log-normal, with each merchant's revenue characterized by a mean e^{r̅e̅v̅}^{ᵢ} and volatility σᵢ. Circuit 304 treats a loan as a short put option on the revenue of the merchant, combined with a risk-free bond. The value of the bond and option are given by:

$$Bond Value = {e}^{( r - {r}^{f} ) T + {l}_{i}} \qquad ( 2 )$$

$$Option Value = {e}^{- {r}^{f} T + {l}_{i}} N ( - d 2 ) - {e}^{\overline{{rev}_{i}}} N ( - d 1 ) \qquad ( 3 )$$

$$where :$$

$$d 1 = \frac{\overline{{rev}_{i}} - {l}_{i} + ( {r}^{f} + 0.5 {σ}_{i}^{2} ) T}{{σ}_{i} \sqrt{T}} , d 2 = d 1 - {σ}_{i} \sqrt{T} ; \qquad ( 4 )$$

N (·) is the cumulative distribution function (CDF) of a normal distribution; e^{l}^{ᵢ} is the credit limit to be determined; r represents the interest rate applied to the borrower; r^{f} represents the discount rate of the financial institution; and T represents the maturity of the loan. The credit limit is determined by e^{l}^{ᵢ}=Bond Value−Option Value, or

$${e}^{( r - {r}^{f} ) T} - 1 = {e}^{- {r}_{f} T} N ( - d 2 ) - {e}^{\overline{{rev}_{i}} - {l}_{i}} N ( - d 1 ) . \qquad ( 5 )$$

Thus, for each proposed interest rate r, solving the above equation determines the credit limit e^{l}^{ᵢ} for a merchant. The default probability is calculated as

$$N ( \frac{rT + {l}_{i} - \overline{{rev}_{i}}}{{σ}_{i} \sqrt{T}} ) . \qquad ( 6 )$$

The discussion illustrates how our approach is deeply rooted in financial theory, with the KMV model representing a special case within our broader framework. Unlike the KMV model, which assumes fixed company liabilities, circuit 304 allows the loan amount to vary up to a predetermined limit. Additionally, circuit 304 makes no assumptions about the revenue distribution, making it versatile and applicable to a wide range of scenarios, including non-publicly listed firms that might cease operation unexpectedly. Circuit 304 further refines this process by leveraging multimodal data, including numerical values, natural language texts, and customer behavior patterns.

Referring to FIG. 3, the calculated default risk, including PD and LGD, can be used to manage the loan in real-time. In one implementation, system 300 may include a credit risk control circuit 306 for this purpose. After issuing a loan with an associated default risk to a merchant, the credit risk control circuit 306 may continuously obtain updates of authorized merchant data in real-time. Based on the updates, system 300 may continuously calculate the default risks. In one implementation, credit risk control circuit 306 may monitor the calculated PD against a predetermined rule for loan management. If the monitored default risk remains within the boundary of the predetermined rules, credit risk control circuit 306 may issue a “pay” instruction to allow the merchant to continue using its day-to-day revenue for regular operations. If the default risk violates the predetermined rule, credit risk control circuit 306 may issue a “freeze” instruction to restrict the merchant's use of its day-to-day revenue. If PD and LGD exceed the threshold levels, credit risk control circuit 306 may issue a “repay” instruction that will enforce repayment at maturity from merchant's e-commerce account at the e-commerce platform to the financial institution. System 300 may further include a loan payor circuit 310 that may execute the instructions generated by credit risk control circuit 306.

System 300 may further include a loan decision database 308 that may record the calculated optimal loan amounts, default risks, and actions taken by loan payor circuit. The recorded information may be provided to data processing and trained subsystem circuit 302 as training data of historical prediction and outcome. Utilizing this historical data enables continuous improvement of the trained subsystem through ongoing updates and training.

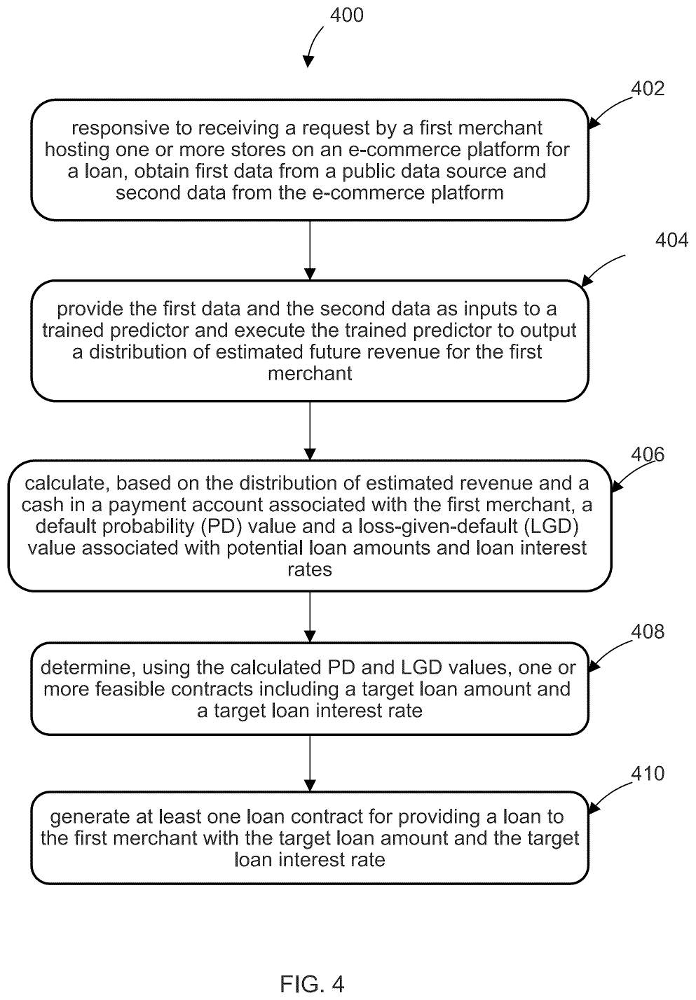

FIG. 4 illustrates a flowchart of a method 400 for generating a loan contract to an e-commerce merchant according to an implementation of the disclosure. Method 400 may be performed by processing devices that may comprise hardware (e.g., circuitry, dedicated logic), computer-readable instructions (e.g., run on a general-purpose computer system or a dedicated machine), or a combination of both. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

As shown in FIG. 4, one or more processing devices may, at 402, responsive to receiving a request by a first merchant hosting one or more stores on an e-commerce platform for a loan, obtain first data from a public data source and second data from the e-commerce platform, wherein the first data and the second data may include a variety of inputs such as historical revenue, transaction history, customer behavior, and other relevant metrics associated with the first merchant's shops, as well as the cash in a payment account linked to the first merchant.

At 404, the one or more processing devices may provide the first data and the second data as inputs to a trained predictor and execute the trained predictor to output a distribution of estimated future revenue for the first merchant.

At 406, one or more processing devices may calculate, based on the distribution of estimated revenue and a cash in a payment account associated with the first merchant, a default probability (PD) value and a loss-given-default (LGD) value associated with potential loan amounts and loan interest rates.

At 408, using the calculated PD and LGD values, the one or more processing devices may determine, using the calculated PD and LGD values, one or more feasible contracts including a target loan amount and a target loan interest rate.

At 410, the one or more processing devices may generate at least one loan contract for providing a loan to the first merchant with the target loan amount and the target loan interest rate.

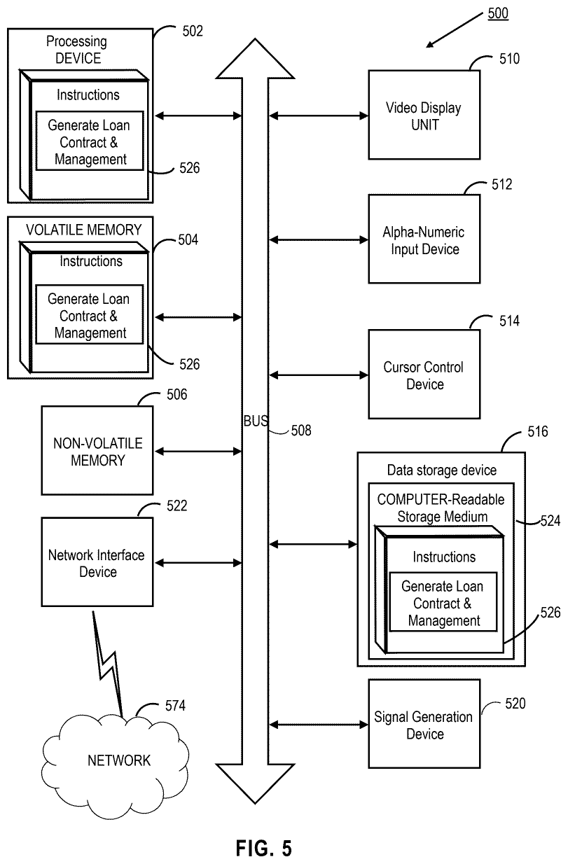

FIG. 5 depicts a block diagram of a computer system 500 operating in accordance with one or more aspects of the present disclosure. In various illustrative examples, computer system 500 may implement operations 118 for generating a loan contract and manage the loan contract as shown in FIG. 1.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processing device 502 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions for performing operations 118 of FIG. 1 for implementing method 400.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A system comprising one or more processing devices and one or more storage devices for storing instructions that when executed by the one or more processing devices cause the one or more processing devices to:
responsive to receiving a request by a first merchant hosting one or more shops on an e-commerce platform for a loan, obtain first data from a public data source and second data from the e-commerce platform;
provide the first data and the second data as inputs to a trained predictor and execute the trained predictor to output a distribution of estimated future revenue for the first merchant;
calculate, based on the distribution of estimated revenue and a cash in a payment account associated with the first merchant, a default probability (PD) value and a loss-given-default (LGD) value associated with potential loan amounts and loan interest rates;
determine, using the calculated PD and LGD values, one or more feasible contracts including a target loan amount and a target loan interest rate; and
generate at least one loan contract for providing a loan to the first merchant with the target loan amount and the target loan interest rate.

2. The system of claim 1, wherein the one or more processing devices are further to:
obtain an update of the second data from the e-commerce platform;
provide the updated second data as inputs to the trained predictor and execute the trained predictor to output an updated distribution of estimated revenue of the first merchant over the repayment term;
determine, based on the recalculated PD value and LGD value, an action to be taken against the first merchant; and
issue an instruction to take the action to a payment control circuit.

3. The system of claim 2, wherein the action comprises a pay action, a lock action, a freeze action, and a repayment action,
wherein responsive to receiving an instruction to take the pay action, the payment control circuit is to allow the first merchant to continue using its day-to-day revenue for regular operations, wherein responsive to receiving an instruction to take the lock action, the payment control circuit is to cause the financial institution to fix a customer account for the first merchant, wherein responsive to receiving an instruction to take freeze action, the payment control circuit is to restrict the first merchant's use of its day-to-day revenue, and wherein responsive to receiving an instruction to take repayment action, the payment control circuit is to cause the e-commerce platform to pay the financial institution using the first merchant's sale revenue according to the repayment term.

4. The system of claim 1, wherein the one or more processing devices are further to:
obtain the second data from the e-commerce platform, the second data comprising sales information relating to a plurality of merchants active on the e-commerce platform, the plurality of merchants comprising the first merchant;
combine the first data and the second data into input data;
perform a principal component analysis on the input data to calculate a set of principal component values with respect to a set of principal components;
integrate the set of principal component values with data specific to operations of the first merchant's shops, and provide both data to the trained transformer neural network module; and
segment, for each shop operated by the first merchant on the e-commerce platform, the revenue of the shop into a plurality of bins, wherein each of the plurality of the bins represents a quantile of probability of revenue for the shop.

5. The system of claim 4, wherein the second data comprises historical data over a time period that includes a plurality of durations, and wherein the second data is represented as a time series of data structures, each data structures corresponding to a specific duration within the time period.

6. The system of claim 5, wherein the trained predictor comprises a trained transformer neural network module, the transformer neural network module comprising a multi-headed attention mechanism with a plurality of heads, wherein each of the plurality of attention heads processes a corresponding data structure associated with a specific time step in the time series.

7. The system of claim 6, wherein the one or more processing devices are further to:
execute the trained transformer neural network module to predict the distribution of revenue across bins for each shop operated by the first merchant on the e-commerce platform, with each bin representing a quantile of the shop's revenue;
synthesize the predicted distributions for the shops into a consolidated cumulative distribution function representing the collateral value of the first merchant over the repayment term of the loan.

8. The system of claim 6, wherein the trained transformer neural network module is trained using training data, the training comprising:
obtaining training data of the plurality of merchants and their shops over a period of time, along with corresponding future revenue data;
providing the training data to the transformer neural network module to generate an intermediate probability distribution over possible revenue bins;
calculating a cross-entropy loss between the intermediate probability distribution and a one-hot encoded vector representing the correct revenue bin; and
iteratively adjusting at least one parameter of the transformer neural network module based on the cross-entropy loss.

9. The system of claim 1, wherein the one or more processing devices are further to:
determine, based on the PD value and the LGD value calculated using the structural bond model, the target loan amount and the target loan interest rate; and
generate a table of PD values and LGD values, and corresponding loan amounts and interest rates.

10. The system of claim 1, wherein, when the estimated future revenue follows a log-normal distribution, the loan is modeled using a structural approach, wherein the loan is represented as a combination of a risk-free bond and a short put option on the collateral.

11. A method comprising:
responsive to receiving a request by a first merchant hosting one or more shops on an e-commerce platform for a loan, obtaining first data from a public data source and second data from the e-commerce platform;
providing the first data and the second data as inputs to a trained predictor and execute the trained predictor to output a distribution of estimated future revenue for the first merchant;
calculating, based on the distribution of estimated future revenue and a cash in a payment account associated with the first merchant, a probability of default (PD) value and a loss-given-default (LGD) value associated with potential loan amounts and loan interest rates;
determining, using the calculated PD and LGD value, one or more feasible contracts including a target loan amount and a target loan interest rate; and
generating at least one loan contract for providing the loan to the first merchant with the target loan amount and the target loan interest rate.

12. The method of claim 11, further comprising:
obtaining an update of the second data from the e-commerce platform;
providing the updated second data as inputs to the trained predictor and execute the trained predictor to output an updated distribution of estimated revenue of the first merchant over the repayment term;
determining, based on the recalculated PD value and LGD value, an action to be taken against the first merchant; and
issuing an instruction to take the action to a payment control circuit.

13. The method of claim 12, wherein the action comprises a pay action, a lock action, a freeze action, and a repayment action,
wherein responsive to receiving an instruction to take the pay action, the payment control circuit is to allow the first merchant to continue using its day-to-day revenue for regular operations, wherein responsive to receiving an instruction to take the lock action, the payment control circuit is to cause the financial institution to fix a customer account for the first merchant, wherein responsive to receiving an instruction to take freeze action, the payment control circuit is to restrict the first merchant's use of its day-to-day revenue, and wherein responsive to receiving an instruction to take repayment action, the payment control circuit is to cause the e-commerce platform to pay the financial institution using the first merchant's sale revenue according to the repayment term.

14. The method of claim 11, further comprising:
obtaining the second data from the e-commerce platform, the second data comprising sales information relating to a plurality of merchants active on the e-commerce platform, the plurality of merchants comprising the first merchant;
combining the first data and the second data into input data;
performing a principal component analysis on the input data to calculate a set of principal component values with respect to a set of principal components;
integrating the set of principal component values with data specific to operations of the first merchant's shops, and providing both data to the trained transformer neural network module; and
segmenting, for each shop operated by the first merchant on the e-commerce platform, the revenue of the shop into a plurality of bins, wherein each of the plurality of the bins represents a quantile of probability of revenue for the shop.

15. The method of claim 14, wherein the second data comprises a historical data over a time period that includes a plurality of durations, and wherein the second data is represented as a time series of data structures, each of the data structures corresponding to a specific duration within the time period.

16. The method of claim 15, wherein the trained predictor comprises a trained transformer neural network module, the transformer neural network module comprising a multi-headed attention mechanism with a plurality of heads, wherein each of the plurality of attention heads processes a corresponding data structure associated with a specific time step in the time series.

17. The method of claim 16, further comprising:
executing the trained transformer neural network module to predict the distribution of revenue across bins for each shop operated by the first merchant on the e-commerce platform, with each bin representing a quantile of the shop's revenue;
synthesizing the predicted distribution for the shops into a consolidated cumulative distribution function representing the collateral value of the first merchant over the repayment term of the loan.

18. The method of claim 16, wherein the trained transformer neural network module is trained using training data, wherein the training comprises:
obtaining training sales data of the plurality of merchants and their shops over a period of time, along with corresponding future revenue data;
providing the training data to the transformer neural network module to generate an intermediate probability of distribution over possible revenue bins;
calculating a cross-entropy loss between the intermediate probability distribution and a one-hot encoded vector representing the correct revenue bin; and
iteratively adjusting at least one parameter of the transformer neural network module based on the cross-entropy loss.

19. The method of claim 11, further comprising:
responsive to determining that the estimated future revenue follows a log-normal distribution, executing a structural bond model that treats the loan as a combination of a risk-free bond and a short put option on the collateral, wherein the collateral comprises the cash in the payment account and the estimated future revenue.

20. A machine-readable non-transitory storage media encoded with instructions that, when executed by one or more processing devices, cause the one or more processing devices to:
responsive to receiving a request by a first merchant hosting one or more shops on an e-commerce platform for a loan, obtain first data from a public data source and second data from the e-commerce platform;
provide the first data and the second data as inputs to a trained predictor and execute the trained predictor to output a distribution of estimated future revenue for the first merchant;
calculate, based on the distribution of estimated revenue and a cash in a payment account associated with the first merchant, a default probability (PD) value and a loss- given-default (LGD) value associated with potential loan amounts and loan interest rates;
determine, using the calculated PD and LGD values, one or more feasible contracts including a target loan amount and a target loan interest rate; and
generate at least one loan contract for providing a loan to the first merchant with the target loan amount and the target loan interest rate.
